(19) United States
(12) Patent Application Publication
(10) Pub. No.: US 2022/0076089 A1
(43) Pub. Date: Mar. 10, 2022

(54) MICROCIRCUIT CARD CUSTOMIZATION

(71) Applicant: STMicroelectronics (Rousset) SAS, Rousset (FR)

(72) Inventor: Philippe ALARY, Puyloubier (FR)

(73) Assignee: STMicroelectronics (Rousset) SAS, Rousset (FR)

(21) Appl. No.: 17/462,768

(22) Filed: Aug. 31, 2021

(30) Foreign Application Priority Data
Sep. 4, 2020 (FR) 2008984

(51) Int. Cl. G06K 19/07

(52) U.S. Cl. CPC G06K 19/0718

(57) ABSTRACT

A microcircuit card is provided with a fingerprint sensor. Customization of the microcircuit card is accomplished by the use of an exchange of data by near-field communications between the microcircuit card and a near-field communication device. A mechanical positioning system associated with the near-field communication device is configured to retain the microcircuit card such that the fingerprint sensor is accessible and near-field communication between the microcircuit card and the near-field communication device is assured. The mechanical positioning system may, in an example where the near-field communication device is a cell phone, be formed by a slot of a protective case for the cell phone.

### PRIORITY CLAIM

This application claims the priority benefit of French Application for Patent No. 2008984, filed on Sep. 4, 2020, the content of which is hereby incorporated by reference in its entirety to the maximum extent allowable by law.

### TECHNICAL FIELD

The present disclosure generally concerns electronic devices and, more particularly, microcircuit cards provided with a biometric sensor (more simply called biometric cards) and their customization methods.

### BACKGROUND

For a user to be able to use a biometric card, it is generally necessary for the biometric data specific to this user to have previously been stored in the card. Such storage of the user's biometric data into the card is performed during so-called card customization, registration or enrollment operations. The implementation of these customization operations appears to be currently constraining for the user.

There is a need to improve current biometric card customization methods.

### SUMMARY

An embodiment overcomes all or part of the disadvantages of known biometric card customization methods.

An embodiment provides a method, wherein steps of customization of a microcircuit card provided with a fingerprint sensor, implemented by the card, are controlled by a near-field communication device.

According to an embodiment, the method comprises the steps of: a) acquisition, by the fingerprint sensor, of biometric data characteristic of a user; and b) storage of the biometric data into a memory of the microcircuit card.

According to an embodiment, the near-field communication device powers the microcircuit card.

According to an embodiment, the device is a cell phone.

According to an embodiment, the microcircuit card is a biometric contactless payment bank card.

According to an embodiment, the microcircuit is held together with the device by a positioning system.

An embodiment provides a positioning system capable of implementing the method such as described.

According to an embodiment, the system comprises a shell for protecting the device comprising a slot for inserting the microcircuit card.

According to an embodiment, the system comprises a jig for aligning the microcircuit card with respect to the device.

An embodiment provides a computer program product, comprising a non-transient storage support adapted to implementing the method such as described.

An embodiment provides a system comprising a microcircuit card and a cell phone, adapted to implementing the method such as described.

### BRIEF DESCRIPTION OF THE DRAWINGS

The foregoing and other features and advantages of the present invention will be discussed in detail in the following non-limiting description of specific embodiments and implementation modes in connection with the accompanying drawings, in which:

FIG. 1 schematically shows an example of a near-field communication system of the type to which the described embodiments and implementation modes apply;

FIG. 2 is a partial simplified top view of an example of a biometric card customization system;

FIG. 3 is a partial simplified top view of an example of a biometric card customization system according to an embodiment;

FIG. 4 is a partial simplified bottom view of the customization system of FIG. 3;

FIG. 5 is a perspective view of a device equipped with a protective shell; and

FIG. 6 is a flowchart illustrating steps of a biometric card customization method according to an implementation mode.

### DETAILED DESCRIPTION

Like features have been designated by like references in the various figures. In particular, the structural and/or functional elements common to the different embodiments and implementation modes may be designated with the same reference numerals and may have identical structural, dimensional, and material properties.

For clarity, only those steps and elements which are useful to the understanding of the described embodiments and implementation modes have been shown and will be detailed. In particular, the generation of the signals and data exchanged in near field as well as the interpretation thereof have not been detailed, the described embodiments and implementation modes being compatible with usual techniques of generation and interpretation of these signals and data.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “front”, “back”, “top”, “bottom”, “left”, “right”, etc., or relative positions, such as terms “above”, “under”, “upper”, “lower”, etc., or to terms qualifying directions, such as terms “horizontal”, “vertical”, etc., unless otherwise specified, it is referred to the orientation of the drawings.

Unless specified otherwise, the expressions “around”, “approximately”, “substantially” and “in the order of” signify within 10%, and preferably within 5%.

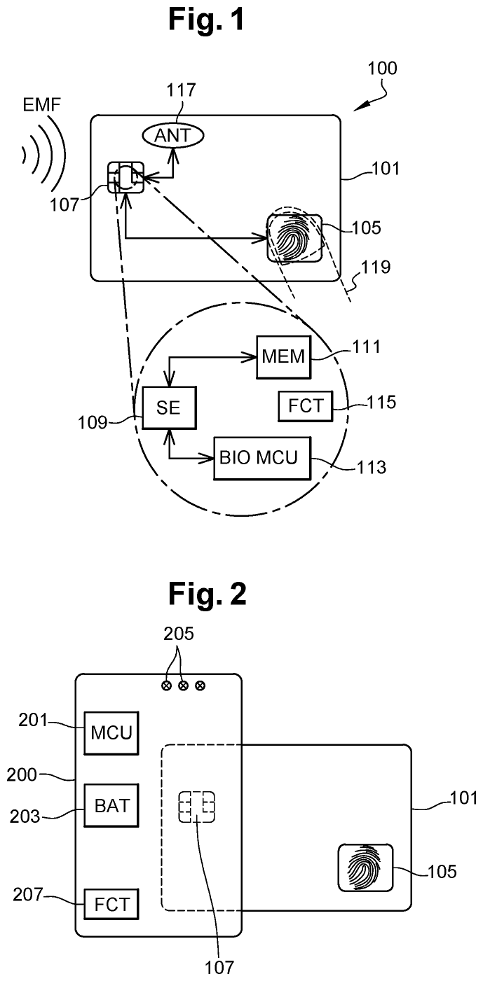

FIG. 1 schematically shows an example of a near-field communication system 100, or NFC system, of the type to which the described embodiments and implementation modes apply.

In the shown example, NFC system 100 comprises a microcircuit card 101. An electromagnetic field EMF is, for example, emitted by a device (not shown) and captured by the card 101 located within range. This particularly enables card 101 to be electrically powered by this device, and to exchange data with this device.

As an example, card 101 is a bank card, for example, a contactless payment card, a transport card, an identification or personal access card, etc.

In the shown example, card 101 is provided with a biometric sensor 105. Biometric sensor 105 is, for example, a fingerprint sensor or reader. Biometric sensor 105 is, for example, located on the front side of card 101, as illustrated in FIG. 1.

In the shown example, biometric card 101 further comprises a chip 107. Chip 107 is symbolized, in FIG. 1, by contacts located on the front side of card 101, for example, flush with the front side of card 101. These contacts are, for example, intended to convey power supply signals and data during a communication with contact between card 101 and a reader (not shown).

In the shown example, chip 107 comprises a processing unit 109 (secure element—SE). Processing unit 109 is, for example, used to process data called secure or secret, that is, data, the access to which is desired to be reserved to certain users or circuits. Processing unit 109 may more specifically have the function, particularly, of protecting secret data, for example data characteristic of a user or owner of card 101, and of performing operations on or by means of these secret data. Processing unit 109 is, for example, configured so that the secret data that it manipulates cannot be discovered by an attacker or a hacker. As an example, processing unit 109 is a microcontroller, for example, a secure microcontroller.

In the shown example, chip 107 further comprises a memory 111 (MEM). As an example, memory 111 may comprise areas intended to store program code instructions and/or variables for the execution of operations by processing unit 109. The memory 111 of chip 107 may further comprise so-called secure areas. As an example, these secure areas may be used to store the secret data of the user of card 101. More particularly, the secure areas of memory 111 may contain one or a plurality of so-called reference fingerprints of the owner of card 101, having data originating from the processing of images acquired by biometric sensor 105, for example, compared therewith during an authentication procedure.

In the shown example, chip 107 further comprises a microcontroller 113 (biometric microcontroller—BIO MCU). Microcontroller 113 is, for example, used to process data acquired by the fingerprint sensor 105 of biometric card 101. Microcontroller 113 is, for example, capable of executing a larger number of instructions per second than processing unit 109, for a substantially equivalent energy consumption. As an example, microcontroller 113 is a biometric microcontroller, for example, a microcontroller dedicated to executing image processing instructions originating from fingerprint sensor 105.

Microcontroller 113 and secure microcontroller 109 may be formed inside and on top of a same substrate, for example, a piece of a wafer made of a semiconductor material. As a variant, microcontrollers 109 and 113 are formed on distinct substrates.

The chip 107 of biometric card 101 may also comprise one or a plurality of other elements. These elements are symbolized, in FIG. 1, by a functional block 115 (FCT).

In the shown example, card 101 further comprises an antenna 117 (ANT). Antenna 117 is, for example, capable of capturing electromagnetic field EMF when card 101 is within its range.

As an example, processing unit 109 may comprise modules or macrocells for managing the electric energy captured by antenna 117 on electromagnetic field EMF. These modules are, for example, used to manage the electric power of (i.e., consumed by) fingerprint sensor 105 and of microcontroller 113 according to the energy available from field EMF.

During a communication or transaction implementing card 101, a step of checking the identity of the user of card 101 may be implemented. In this case, the user is, for example, asked to lay a finger 119 on fingerprint sensor 105. One or a plurality of images of the user's finger 119 is, for example, acquired by fingerprint sensor 105. The image(s) acquired by fingerprint sensor 105 are then, for example, processed by microcontroller 113 to extract therefrom biometric characteristics, for example, singular points or minutiae. These minutiae are then, for example, compared with so-called reference minutiae, previously stored for example in the memory 111 of card 101, to control the identity of the user of card 101.

The storage of the user's reference minutiae into card 101 is performed during so-called operations of customization, registration, or enrollment of card 101. To perform these operations, the user generally has to go to a specialized counter, for example, a bank teller in the case where card 101 is a bank card. The bank may, as a variation, provide shipping a device for customizing card 101, for example, the device discussed hereabove in relation with FIG. 2, to the user's home.

FIG. 2 is a partial simplified top view of an example of a system for customizing a card, for example, the biometric card 101 previously discussed in relation with FIG. 1.

In the shown example, card 101 is inserted into an electronic device 200. Device 200 corresponds, in this example, to a usual biometric card customization device. More particularly, device 200, for example, enables to store, in card 101, reference minutiae of the user of card 101.

In the shown example, device 200 comprises a lateral slot or notch intended to receive card 101. Device 200 is, for example, adapted to communicating with contact with card 101. As an example, device 200 may comprise contacts (not shown) positioned opposite the contacts of chip 107 of card 101 when the latter is inserted into device 200.

In the shown example, device 200 comprises a microcontroller 201 (MCU).

Microcontroller 201 is, for example, a main processing unit of device 200. As an example, microcontroller 201 enables to control operations of image acquisition by the fingerprint sensor 105 of card 101, of processing of these images to extract the reference minutiae therefrom, and of storage of the reference minutia into card 101.

In the shown example, device 200 further comprises an embedded energy source, for example, a battery 203 (BAT). In a case where device 200 is intended to be used in different countries, this, for example, enables the manufacturer of device 200 to do away with constraints specific to power distribution networks of these different countries. Device 200 may as a variation be equipped with a mains supply.

In the shown example, device 200 further comprises light indicators, for example, light-emitting diodes 205, or LEDs. Diodes 205 are, for example, located on the front side of device 200. Diodes 205 may be all of the same color or of different colors. As an example, diodes 205 enable to guide the user on execution of the operations of customization of card 101.

Device 200 may also comprise one or a plurality of other elements. These elements are symbolized, in FIG. 2, by a functional block 207 (FCT).

A disadvantage of device 200 lies in the fact that its use is generally considered to be not so user-friendly by the user of card 101. This is particularly due to the fact that diodes 205 provide strongly limited information and indication display possibilities. Further, the delivery and the shipping of device 200 are generally performed at the expense of the user of card 101. These practical and economical disadvantages tend to hinder the adoption of biometric cards such as card 101.

Another disadvantage of device 200 lies in the fact that its use generally occurs only once, typically a few minutes only, in the lifetime of card 101. Further, in a case where the user desires to replace card 101, for example, with another more recent card, device 200 risks no longer operating with this other card. In addition to the previously-mentioned economical impact, the manufacturing and the use of customization device 200 thus also have an ecological impact, which should desirably be eliminated.

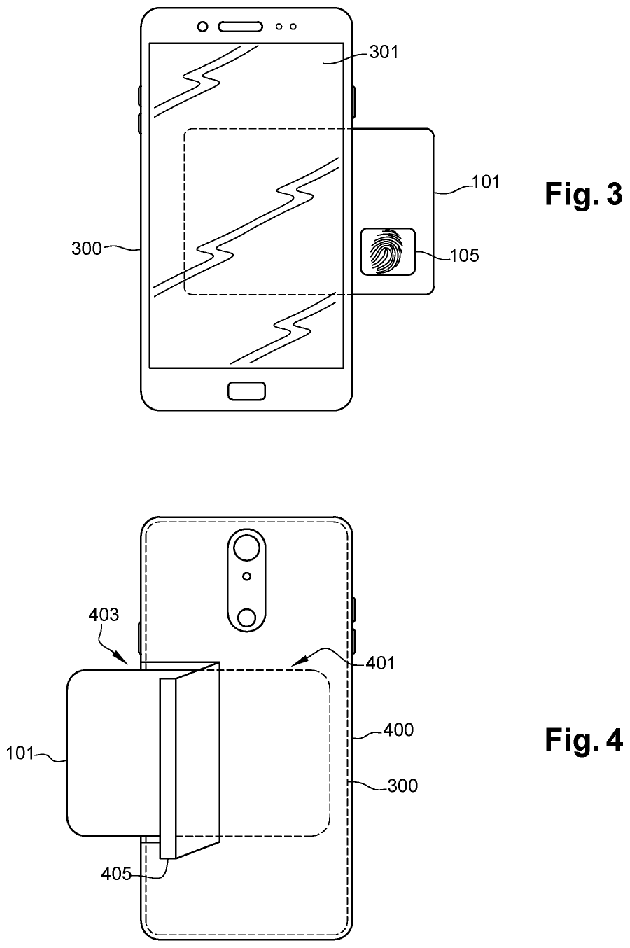

FIG. 3 is a partial simplified top view of a biometric card customization system, for example, card 101, according to an embodiment.

In the shown example, biometric card 101 is placed at the back of a cell phone 300, for example, against a back side of cell phone 300. Card 101 is, for example, positioned so that cell phone 300 does not totally cover the front side of card 101. More particularly, card 101 is positioned so that fingerprint sensor 105 is accessible by the user.

Generally, cell phone 300 is capable of communicating in near field with card 101, as previously described in relation with FIG. 1. As an example, cell phone 300 comprises a near-field communication antenna (not shown), for example, an antenna similar to the antenna 117 previously described in relation with FIG. 1. Card 101 is then positioned so that the antenna 117 of card 101 is substantially aligned with respect to the antenna of cell phone 300. This, for example, allows an optimal coupling between card 101 and cell phone 300.

In the shown example, cell phone 300 comprises a computer program product, comprising a non-transient storage support adapted to implementing a method of customization of card 101.

Cell phone 300 is, for example, used as an interface for customizing, in near field, biometric card 101. More particularly, instructions and information linked to the workflow of customization of biometric card 101 are, for example, displayed for the user, on a screen 301 of cell phone 300. As an example, drawings, diagrams, animations and/or progression bars may in particular be displayed by the screen 301 of phone 300 to guide the user in the execution of the operations of customization of card 101 and to inform him/her of the success or the failure of these operations.

An advantage of the embodiment described in relation with FIG. 3 lies in the fact that the use of cell phone 300 enables to greatly ease the execution of the operations of customization of biometric card 101, particularly by improving the user-friendliness of the interface as compared with the device 200 of FIG. 2. Further, due to the fact that many people already have a cell phone capable of communicating in near field such as cell phone 300, the operations of customization of card 101 may be executed without need for the user to go to a counter or get a device 200.

Another advantage of this embodiment lies in the fact that the program code instructions of the computer program product of cell phone 300 may be updated in case of a replacement of biometric card 101 with another more recent card, for example having a different architecture or components.

This thus enables a decrease in cost and ecological impact linked to the operations of customization of card 101.

FIG. 4 is a partial simplified bottom view of the customization system of FIG. 3.

In the shown example, cell phone 300 is placed in a case or shell 400. Shell 400 is, for example, a protective shell particularly enabling to protect cell phone 300 against possible degradations that may be caused, for example, by a shock or a fall.

In the shown example, shell 400 comprises a housing 401. Housing 401, for example, enables to mechanically hold card 101 together with cell phone 300, for example, during operations of customization of card 101. This particularly enables to avoid complex manipulations, for example where the user would have to hold both cell phone 300 and card 101 while positioning his/her finger on fingerprint sensor 105 and while potentially manipulating the screen to carry out the procedure. This further enables to avoid a risk of removal of card 101 away from cell phone 300 during customization operations, which would be likely to cause a failure of the communication.

Housing 401 is, for example, formed across the thickness of shell 400. Housing 401 is, for example, accessible from a slot 403 located on one side of shell 400. As illustrated in FIG. 4, slot 403, for example, enables to insert, perpendicularly to the longitudinal axis of cell phone 300, card 101 into housing 401 of shell 400. As illustrated in FIG. 4, housing 401, for example, has a length, or depth, smaller than the length of card 101. This particularly enables to ascertain that the fingerprint sensor 105 of card 101 remains accessible by the user when card 101 is bottomed in housing 401.

Housing 401 is, for example, formed to guarantee an optimal coupling between cell phone 300 and card 101 during operations of customization of card 101. More particularly, housing 401 is, for example, formed so that, when card 101 is bottomed in housing 401, the antenna 117 of card 101 is aligned with respect to the near-field communication antenna (not shown) of cell phone 300. The risk of communication errors during operations of customization of card 101 is thus minimized.

In the shown example, shell 400 further comprises a flap 405. Flap 405, for example, enables to close housing 401, particularly slot 403 for inserting card 101, when card 101 is not present. The closing of flap 405 particularly enables to avoid for water or foreign bodies, such as dust, to penetrate into housing 401. The closing of flap 405 may further contribute to the general mechanical stiffness of shell 400.

Although an embodiment where card 101 is held together with phone 300 by shell 400 has been described in relation with FIG. 4, this embodiment is adaptable by those skilled in the art to other types of positioning systems. In particular, it will be within the abilities of those skilled in the art to adapt what is described in relation with FIG. 4 to a case where card 101 is positioned with respect to phone 300 by using an alignment jig. The alignment jig may be adapted to each model of phone 300, or be designed to be adapted to several types of phones. As an example, the alignment jig may be made of cardboard, of plastic material, etc. For example, a cardboard jig could be mailed in a standard envelope at a low cost and recycled after use.

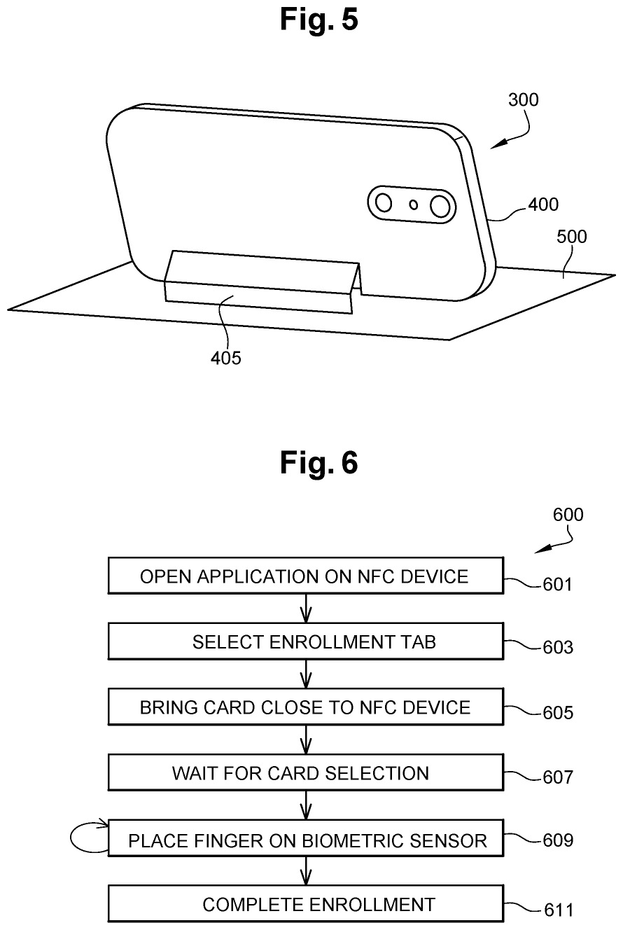

FIG. 5 is a perspective view of a device equipped with a protective shell, for example, cell phone 300 provided with shell 400.

In the shown example, shell 400 is used to maintain phone 300 in an inclined position with respect to a support 500. More particularly, flap 405 of shell 400 enables to provide a stable stand on support 500 when phone 300 is laid on the side. This eases the use of phone 300, for example in the case of a viewing of video content on screen 301 of cell phone 300.

FIG. 6 is a flowchart 600 illustrating successive steps of a method of customization of a biometric card, for example, biometric card 101, according to an implementation mode.

During a step 601 (OPEN APPLICATION ON NFC DEVICE), the user launches an application on cell phone 300. In the case where the card 101 to be customized is a bank card, the application, for example, is a so-called online banking application, that is, an application from which clients of the bank may in particular check their account balance, make bank transfers, etc. to which biometric card customization functionalities have been integrated. As a variant, the application is an application reserved to biometric card customization.

During another step 603 (SELECT ENROLLMENT TAB), the user selects, for example, a tab of the application providing access to the biometric card customization functionalities, in the case, for example, where the application comprises functionalities other than card customization. This, for example, enables to start operations of customization of card 101.

Before the beginning of the operations of customization of card 101, for example, at step 601 or at step 603, an authentication operation may be provided to check the identity of the user who wishes to customize card 101. As an example, according to the desired security level, the authentication may be performed by one or a plurality of factors, for example, selected from among a secret code (preferably sent separately), a fingerprint control by a sensor (not shown) of cell phone 300, and a facial recognition by an image sensor (not shown) of cell phone 300.

During still another step 605 (BRING CARD CLOSE TO NFC DEVICE), the user is asked to bring the card 101 to be customized towards cell phone 300. The user can then, for example, place card 101 close to phone 300, as previously discussed in relation with FIG. 3, or insert card 101 into housing 403 if cell phone 300 is provided with shell 400. As an example, screen 301 of cell phone 300 may display a diagram or an animation enabling to assist the user in the execution of this operation.

During still another step 607 (WAIT FOR CARD SELECTION), the user is asked to wait for card 101 to be selected by cell phone 300. During this step, cell phone 300 for example emits an electromagnetic field to attempt detecting card 101. Once card 101 has been detected, a near-field communication is established between card 101 and phone 300, and a secure communication channel is for example opened.

During still another step 609 (PLACE FINGER ON BIOMETRIC SENSOR), the user is asked to place a finger on the fingerprint sensor 105 of biometric card 101. At least one image of the fingerprint of the user's finger is then captured by sensor 105 and then processed to extract the reference minutiae therefrom. These reference minutiae are then stored in card 101, for example, in memory 111 of chip 107. These operations may, for example, be repeated for one or a plurality of other fingers of the same user and/or for one or a plurality of other fingers of another user to whom the use of card 101 is also desired to be allowed.

During still another step 611 (COMPLETE ENROLLMENT), the operations of customization of card 101 are completed. The secure channel opened at step 607 is then, for example, closed. Hardware and/or software operations may be provided to guarantee an irreversibility of the customization method. This enables, in particular, to avoid for an ill-intentioned person to be able to replace the reference minutia stored in card 101 at the end of the execution of the method of customization of card 101.

Various embodiments, implementation modes, and variants have been described. Those skilled in the art will understand that certain features of these various embodiments, implementation modes, and variants, may be combined and other variants will occur to those skilled in the art. In particular, the described embodiments and implementation modes are not limited to the architecture of card 101 such as discussed hereabove in relation with FIG. 1, but more generally apply to any microcircuit card capable of implementing near-field communication functions and provided with a biometric sensor.

Further, although embodiments and implementation modes taking as an example the customization of biometric card 101 from cell phone 300 have been described hereabove, it will be within the abilities of those skilled in the art to transpose these embodiments and implementation modes to the use of other NFC devices such as touch pads, laptop computers, etc.

Finally, the practical implementation of the described embodiments, implementation modes, and variants is within the abilities of those skilled in the art based on the functional indications given hereabove. In particular, the practical implementation of the implementation mode of the customization method discussed in relation with FIG. 6, and more particularly of the authentication operations, is within the abilities of those skilled in the art. Further, the implementation of the application enabling to customize biometric cards from an NFC device is within the abilities of those skilled in the art.

1. A method for customization of a microcircuit card provided with a fingerprint sensor, comprising:
retaining the microcircuit card within a mechanical positioning system associated with a near-field communication device such that the fingerprint sensor is accessible and near-field communication between the microcircuit card and the near-field communication device is assured;
engaging in near-field communications between the microcircuit card and the near-field communication device in connection with execution of a process by the near-field communication device to perform customization of the microcircuit card.

2. The method according to claim 1, further comprising:
acquiring an image by the fingerprint sensor;
transmitting the image by near-field communication to the near-field communication device;
processing of the image by the near-field communication device to acquire biometric data;
transmitting the biometric data by near-field communication to the microcircuit card; and
storing of the biometric data into a memory of the microcircuit card.

3. The method according to claim 1, wherein the near-field communication device powers the microcircuit card.

4. The method according to claim 1, wherein the near-field communication device is a cell phone, and wherein the mechanical positioning system is provided by a protective case for the cell phone.

5. The method according to claim 4, wherein the mechanical positioning system of the protective case comprises a slot configured for insertion of the microcircuit card in a position such that the fingerprint sensor is accessible.

6. The method according to claim 5, wherein the protective case includes a flap configured to close said slot.

7. The method according to claim 6, wherein said flap is configured to further function when open as a stand for supporting a resting orientation of the cell phone.

8. The method according to claim 1, wherein the near-field communication device is a cell phone, and wherein the mechanical positioning system is provided by a jig configured to align the microcircuit card with respect to the cell phone in a position such that the fingerprint sensor is accessible.

9. The method according to claim 8, wherein the alignment jig is specifically adapted to a model of the cell phone.

10. The method according to claim 8, wherein the alignment jig is configured to be mailed to a user of the cell phone.

11. The method according to claim 8, wherein the alignment jig is made of a recyclable material.

12. The method according to claim 1, wherein the microcircuit card is a biometric contactless payment bank card.

13. A system, comprising:
a microcircuit card provided with a fingerprint sensor;
a near-field communication device;
a mechanical positioning system associated with said near-field communication device that is configured to retain the microcircuit card such that the fingerprint sensor is accessible and near-field communication between the microcircuit card and the near-field communication device is assured;
wherein said microcircuit card and near-field communication device are configured to engage in near-field communications in connection with execution of a process by the near-field communication device to perform customization of the microcircuit card.

14. The system according to claim 13, wherein said process comprises:
receiving by near-field communication an image acquired by the fingerprint sensor;
processing of the image by the near-field communication device to acquire biometric data; and
transmitting the biometric data by near-field communication to the microcircuit card for storage into a memory of the microcircuit card.

15. The system according to claim 13, wherein the near-field communication device powers the microcircuit card.

16. The system according to claim 13, wherein the near-field communication device is a cell phone, and wherein the mechanical positioning system is provided by a protective case for the cell phone.

17. The system according to claim 16, wherein the mechanical positioning system of the protective case comprises a slot configured for insertion of the microcircuit card in a position such that the fingerprint sensor is accessible.

18. The system according to claim 17, wherein the protective case includes a flap configured to close said slot.

19. The system according to claim 18, wherein said flap is configured to further function when open as a stand for supporting a resting orientation of the cell phone.

20. The system according to claim 13, wherein the near-field communication device is a cell phone, and wherein the mechanical positioning system is provided by a jig configured to align the microcircuit card with respect to the cell phone in a position such that the fingerprint sensor is accessible.

21. The system according to claim 20, wherein the alignment jig is specifically adapted to a model of the cell phone.

22. The system according to claim 20, wherein the alignment jig is configured to be mailed to a user of the cell phone.

23. The system according to claim 22, wherein the alignment jig is made of a recyclable material.

24. The system according to claim 13, wherein the microcircuit card is a biometric contactless payment bank card.
